(19) United States
(12) Patent Application Publication
(10) Pub. No.: US 2022/0415292 A1
(43) Pub. Date: Dec. 29, 2022

(54) Broad spectrum audio device designed to accelerate the maturation of stringed instruments.

(71) Applicants: Gerald Francis Brown, Chapel Hill, NC (US); Isaac Daniel Derr, Hillsborough, NC (US)

(72) Inventors: Gerald Francis Brown, Chapel Hill, NC (US); Isaac Daniel Derr, Hillsborough, NC (US)

(21) Appl. No.: 17/357,879

(22) Filed: Jun. 24, 2021

(51) Int. Cl. G10H 1/00; G10D 3/14; H04R 1/46

(52) U.S. Cl. CPC G10H 1/0091; G10D 3/14; H04R 1/46

(57) ABSTRACT

The present invention comprises a device and process designed to accelerate the maturation of stringed musical instruments, composed of but not limited to a broad spectrum audio generator coupled with one or more fasteners via one or more armatures dimensioned to allow easy installation, secure attachment, and easy uninstallation from the stringed musical instrument.

### FIELD OF INVENTION

The invention relates to a device and process of accelerating the aging process of stringed musical instruments for the purpose of ameliorating the sonic qualities of stringed musical instruments.

### BACKGROUND

It is known that stringed musical instruments that have been played extensively garner superior sonic qualities when compared to similar stringed musical instruments that have not been played for the same amount of time. Specifically wooden bodied stringed musical instruments such as the guitar, bass, mandolin, violin, viola, etc. serve to benefit from extended play time. Many wish to imbue new or lightly used instruments with the same sonic qualities of extensively played instruments but lack the time necessary to achieve the results of hundreds if not thousands of hours of playtime. This invention autonomously simulates the physical auditory conditioning of extensive play via transmitting a sonic approximation of the complex polyphonic timbre of the instrument in question directly into the stringed musical instrument. The agitation of a stringed musical instrument via mechanical or vibratory methods cannot produce the menagerie of frequencies required to fully encompass the sonic range of any musical instrument. This invention is capable of producing a vast array of fundamental and harmonic frequencies at any given moment, each frequency allowing for variable pitch and amplitude, fulfilling the need to both accurately and autonomously imbue stringed musical instruments with the superior sonic characteristics of a regularly played vintage instrument, without necessitating extensive hands on play time. In addition, this device circumvents physical wear to the frets and strings of the instrument saving the user both time and maintenance costs while still garnering the results of extended play.

### A SHORT SUMMARY OF THE INVENTION

The present invention serves the needs of those who deal with, manufacture, and play stringed musical instruments by providing a device that closely emulates the physical conditioning otherwise only obtainable through prolonged playtime. The process of emulating playtime will henceforth be referred to as “maturation.” The present invention is purpose built to attach a broad spectrum audio device to virtually any stringed musical instrument via a cantilever action by entrapping the device at the tangent point formed between the saddle or bridge of the stringed musical instrument and one or more strings of the stringed musical instrument, ensuring a safe yet positive acoustic couple between the present invention and the stringed musical instrument. The present invention uses a large bandwidth of sonic frequencies that encompass the natural range of many if not all stringed musical instruments and allows the user to selectively curate which frequencies to condition their stringed musical instrument, whether the frequencies be synthesized by the broad spectrum audio device of the present invention, or via an external processor that transmits audio data to the device by wireless or wired connection.

The present invention is composed of, but not limited to: an attachment rail, hook, or any other suitable configuration of one or more fasteners coupled to a broad spectrum audio device via one or more armatures. The attachment rail, hook, or any other suitable configuration of one or more fasteners affix the device behind the strings of a stringed musical instrument, allowing the device to utilize the bridge, bridge pins, and or saddle of the stringed musical instrument as a fulcrum, creating a cantilever action, and a means of autonomously transmitting audio waves from the aforementioned broad spectrum audio device into the bridge, bridge pins, and or saddle of the stringed musical instrument, accelerating the maturation of the stringed musical instrument; wherein the attachment rail, hook, or any other suitable configuration of one or more fasteners and armature or armatures are dimensioned to allow the attachment rail, hook, or any other suitable configuration of one or more fasteners to rest at the tangent point formed by the strings and the bridge and or saddle of the stringed musical instrument, positioning the audio generator against the bridge, bridge pins, and or saddle of the stringed musical instrument. When positioned correctly, the device cannot become detached from the stringed musical instrument without the direct intent of the user due to the dimensions of the armature or armatures and fastener or fasters.

These and other embodiments, advantages, and features of this invention will be apparent from the following description, drawings, and appended claims.

### BRIEF DESCRIPTION OF THE DRAWING

FIG. 1. A front view of an embodiment of the device attached to the strings of a guitar.

FIG. 2. An expanded view of FIG. 1 highlighting the means of attaching the device to the guitar.

FIG. 3. A side view of an embodiment of the device attached to the strings of a guitar.

FIG. 4. An expanded view of FIG. 2 highlighting the means of attaching the device to the guitar.

FIG. 5. A cross section view of a guitar looking toward the butt of the guitar highlighting the means of attaching the device to the guitar.

FIG. 6. A front view of an alternative embodiment of the device attached to the strings of a guitar.

FIG. 7. An expanded view of FIG. 6 highlighting the means of attaching the device to the guitar.

FIG. 8. A side view of an alternative embodiment of the device attached to the strings of a guitar.

FIG. 9. An expanded view of FIG. 8 highlighting the means of attaching the device to the guitar.

FIG. 10. A cross section view of a guitar looking toward the butt of the guitar highlighting the means of attaching an alternative embodiment of the device to the guitar.

FIG. 11. A front view of an alternative embodiment of the device attached to the strings of a guitar.

FIG. 12. An expanded view of FIG. 11 highlighting the means of attaching the device to the guitar.

FIG. 13. A side view of an alternative embodiment of the device attached to the strings of a guitar.

FIG. 14. An expanded view of FIG. 13 highlighting the means of attaching the device to the guitar.

FIG. 15. A cross section view of a guitar looking toward the butt of the guitar highlighting the means of attaching an alternative embodiment of the device to the guitar.

FIG. 16. A perspective view of an embodiment of the device attached to the strings of a mandolin.

FIG. 17. An expanded view of FIG. 16 highlighting the means of attaching the device to the mandolin.

FIG. 18. A perspective view of an alternative embodiment of the device attached to the strings of a violin.

FIG. 19. An expanded view of FIG. 18 highlighting the means of attaching the device to the violin.

FIG. 20. A perspective view of an alternative embodiment of the device attached to the strings of a banjo.

FIG. 21. An expanded view of FIG. 20 highlighting the means of attaching the device to the banjo.

### DETAILED DESCRIPTION

The object of the present invention is to provide a device and method to accelerate the maturation of stringed musical instruments. The present invention is specifically designed to universally affix a broad spectrum audio device to any stringed musical instrument via a cantilever action by entrapping the device at the tangent point formed between the saddle or bridge of the stringed musical instrument and one or more strings of the stringed musical instrument, ensuring an efficient and safe acoustic couple between the present invention and the stringed musical instrument. The device is composed of, but not limited to a broad spectrum audio device that is capable of generating frequencies from around 30 hz to 22 khz, easily encompassing the sonic range of most if not all stringed musical instruments, one or more armatures used to correctly position the present invention on the stringed musical instrument, and one or more fasteners that, when correctly positions at the tangent point formed between the strings and saddle or bridge of a musical instrument acoustically integrate the device with the instrument. The aforementioned broad spectrum audio device serves to autonomously simulate the acoustic conditions of extended play and, in doing so, accelerates the otherwise lengthy maturation process of said musical instrument. Specifically wooden bodied stringed musical instruments such as the guitar, bass, mandolin, violin, viola, etc. serve to benefit from this device, all of which possess a bridge that acts as the primary acoustic transmission point between the sonic waves generated by the strings of the instrument and the body of said instrument. Said bridge also serves as the transmission point for the audio generated by the present invention, greatly enhancing the realism of simulated play, further aiding in the effectiveness of accelerating the maturation process. Some electric instruments such as but not limited to the electric guitar, electric mandolin, electric bass, electric ukulele, etc. may also serve to benefit from the present invention.

The broad spectrum audio device can be configured to either generate audio frequencies or receive frequencies transmitted from an external source via a hard wire connection or via wireless audio data. The broad spectrum audio device is composed of but not limited to an DAC (Digital Audio Converter) that is capable of receiving and decoding digital audio signal, whether via a cable or wireless connection, and converting it into electric AC signal and an amplifier circuit that is capable of amplifying said AC signal in order to drive a coil for the purpose of moving either a speaker cone or transducer element for the purpose of transmitting audio to the stringed musical instrument. Likewise the broad spectrum audio device is capable of receiving analog audio signals via an auxiliary input for the purpose of playing external analogue audio signals through the amplifier circuit in order to drive a speaker or transducer element as previously described. The broad spectrum audio device is capable of receiving power from either an internal battery or from an external 120 v AC to DC rectifier power supply.

The present invention is a device composed of, but not limited to: an attachment rail, hook, or any other suitable configuration of one or more fasteners coupled to a broad spectrum audio generator via one or more armatures. The attachment rail, hook, or any other suitable configuration of one or more fasteners affixes the device behind one or more strings of a stringed musical instrument, allowing the device to utilize the bridge, bridge pins, and or saddle of the stringed musical instrument as a fulcrum, creating a cantilever action, and a means of autonomously transmitting audio waves from the aforementioned broad spectrum audio generator into the bridge, bridge pins, and or saddle of the stringed musical instrument, accelerating the maturation of the stringed musical instrument; wherein the attachment rail, hook, or any other suitable configuration of one or more fasteners and armature or armatures are dimensioned to allow the attachment rail, hook, or any other suitable configuration of one or more fasteners to rest at the tangent point formed by one or more strings and the bridge and or saddle of the stringed musical instrument, positioning the audio generator against the bridge, bridge pins, and or saddle of the stringed musical instrument so that the device cannot become unintentionally detached from the stringed musical instrument.

When affixed to a stringed musical instrument, the broad spectrum audio device is coupled to the stringed musical instrument via a configuration of one or more fasteners that are in turn connected to the broad spectrum audio device via one or more armatures. The device is held to the instrument due to the configuration of fasteners being entrapped by one or more strings so that the device may not become unintentionally detached from the stringed musical instrument. Furthermore the broad spectrum audio device is held against any number of suitable bridge components known to the Art by the force of gravity acting on the mass of the present invention. Due to the specific dimension of the armature or armatures the force of gravity is redirected into the bridge components of the instrument via a cantilever action. At no point, assuming proper installation, is the device affixed to the strings, bridge, or any other component of the stringed musical instrument via friction, adhesion, spring tension, suction, or a “gripping” action.

The present invention is entrapped by a string or strings of a stringed musical instrument, providing a vertically or semi vertically positioned stringed musical instrument, via a cantilever action. Said cantilever action utilizes a string or strings of the aforementioned instrument as a point of leverage for the fastener or fasteners, so that any bridge or bridge component known to the Art, acts as a fulcrum over which the majority of the weight of the device is balanced. When the fastener or fasteners are correctly positioned behind the strings and buttressed by the bridge or saddle, the fastener or fasteners cannot be freed from this configuration without the direct intent of the user. The gravitational force acting on the device is subsequently transferred into the bridge component that the broad spectrum audio device is levered over. In addition, the force of gravity also applies the weight of the device to the bridge or saddle of the stringed musical instrument via the fastener or fasteners creating a second point of acoustic coupling for the transfer of audio waves generated by the broad spectrum audio device. Said downward force not only serves to secure the device but also aids in a more efficient sonic transfer between the device and the aforementioned instrument. It is known in the Art that as a sound source grows nearer to a physical body, the transfer of sonic energy between the sound source and acoustic body increases and, on contacting the physical body, the efficiency of sonic transfer greatly increases. As the force creating an acoustic bond between a sound source and a physical body increases, so too does the efficiency of the sonic transfer. The present invention takes advantage of these physical properties as the weight of the device is firmly coupled to the natural sonic entry points of the stringed musical instrument, whether the device be coupled to the pins, bridge, and or saddle of the stringed musical instrument.

The outer extremities of the device are composed of a material that, when positioned at the tangent point formed by the strings and bridge or saddle of a stringed musical instrument, does not significantly hamper the ability of the strings to vibrate. Due to the rigidity of the material and close proximity of the fastener or fasteners to the bridge the strings are allowed to sympathetically vibrate with any of the frequencies generated by the device. Metal, glass, plastic, wood, or any other such rigid material would be suitable but metal has been determined to have superior acoustical properties due to its density and rigidity.

The broad spectrum audio device may either be permanently affixed to one or more armatures and subsequent configuration of one or more fasteners or the device may be configured so that the broad spectrum audio device is removable from a substructure comprised of but not limited to one or more armatures and subsequent configuration of one or more fasteners. The ability to interchange broad spectrum audio devices allows the manufacturer or user to incorporate rapidly changing technology and insure long term relevancy of the present invention.

The present invention is dimensioned so that, on proper installation, sonic frequencies are transmitted efficiently from the broad spectrum audio device into the bridge of the stringed musical instrument. Due to the efficiency at which audio waves are transmitted from the device into the bridge of the aforementioned instrument, the audio waves are subsequently transmitted into the body of the stringed musical instrument with minimal loss of sonic energy to heat or “chatter.”

The present invention, whether permanently bound to a configuration of one or more armatures and fasteners, or temporarily inserted within a substructure comprised of but not limited to the previously mentioned components, as a whole comprises an integral structure composed of a broad spectrum audio device, armature or armatures, and any appropriate configuration of one or more fasteners.

The present invention, comprising a broad spectrum audio device, is designed so that the user may select one or more waveforms each comprising a variable wave shape, frequency, and amplitude, that are specific to the range and tuning of any stringed musical instrument. For example, the acoustic guitar, tuned to standard tuning, the fundamental frequencies of the strings: E2 82.41 Hz, A2 110.00 HZ, D3 146.83 Hz, G3 196.00 Hz, B3 246.94, and E4 329.63 Hz are all well within the range of output of the broad spectrum audio device, so too are the overtones of a guitar tuned to standard tuning. The broad spectrum audio device whether via internal software or with the aid of an external processor is capable of receiving user input in order to generate any number of frequencies within its sonic range of 30 Hz to 22 kHz in order to create a vast array of frequency combinations tailored to the tuning and frequency response specific to any instrument. Thus the user is given the option of not only choosing which fundamental frequencies they wish to exercise, but are also given the option to exercise the overtones of their instruments, whether as a primary exercise or in addition to the fundamental frequencies of their musical instrument.

The present invention, comprising of a broad spectrum audio speaker, presuming a stringed musical instrument to which the device is affixed, is capable of not only receiving audio data from an internal or external processor, but is also capable of receiving real time audio feedback from the aforementioned musical instrument via an internal microphonic element and decoding said audio feedback, whether internally or via an external microcontroller or processor, so that the user may analyze the metrics of the maturation process and adjust the settings of the device accordingly.

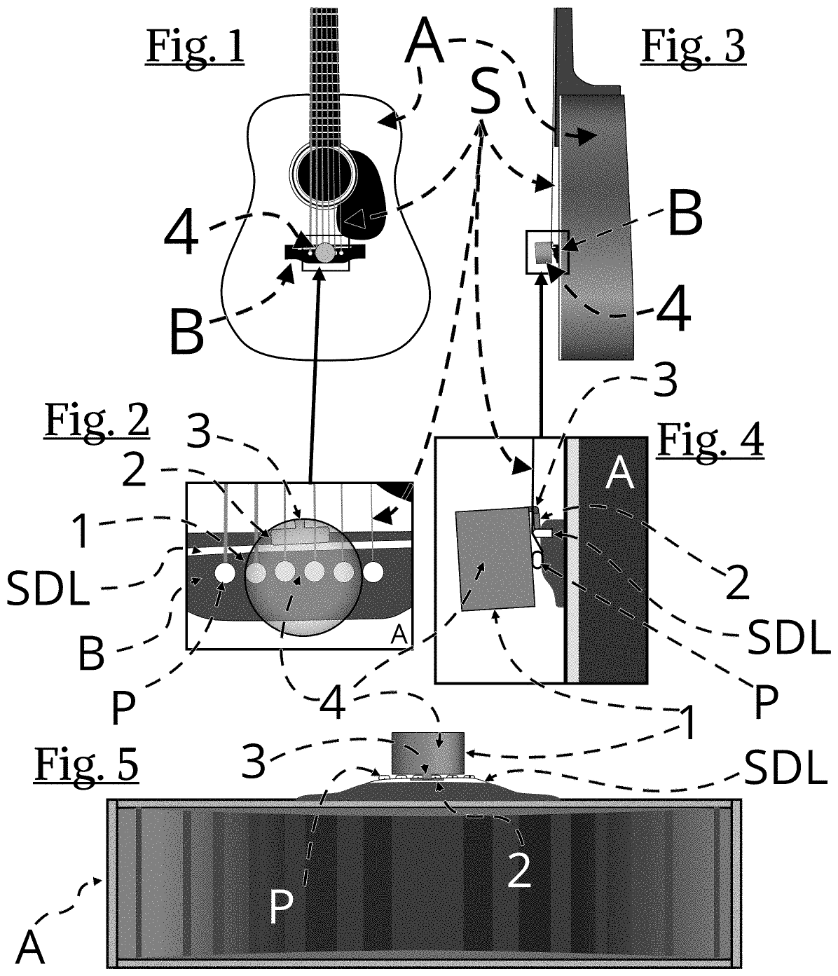

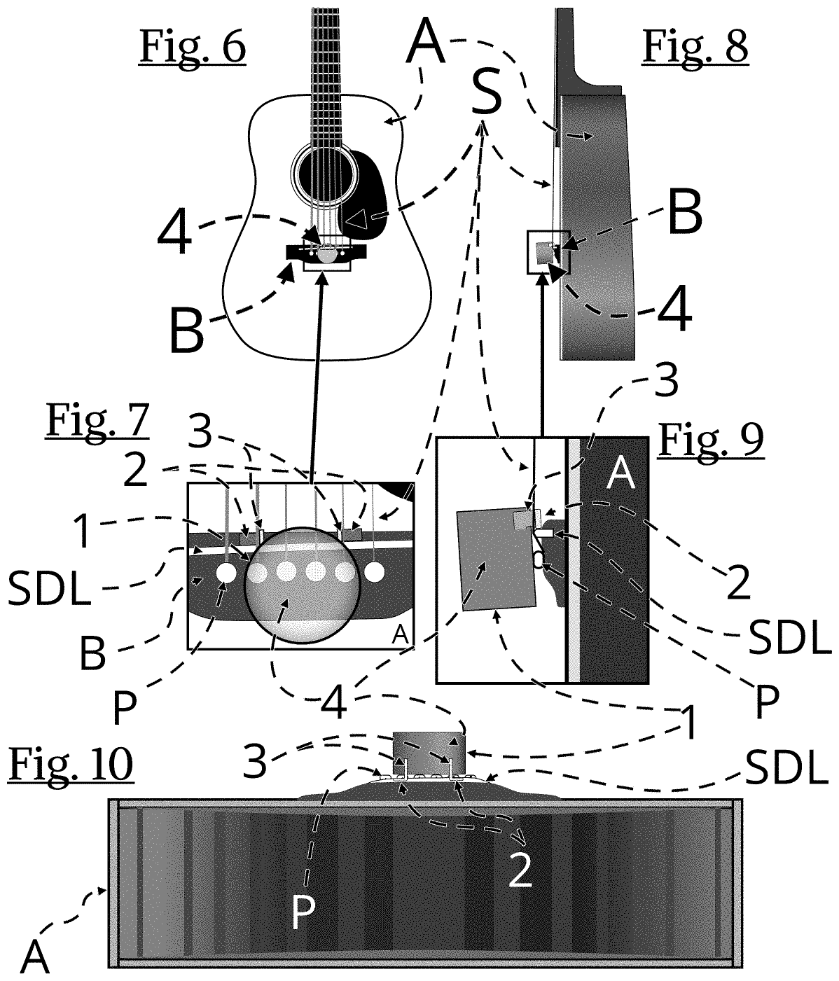

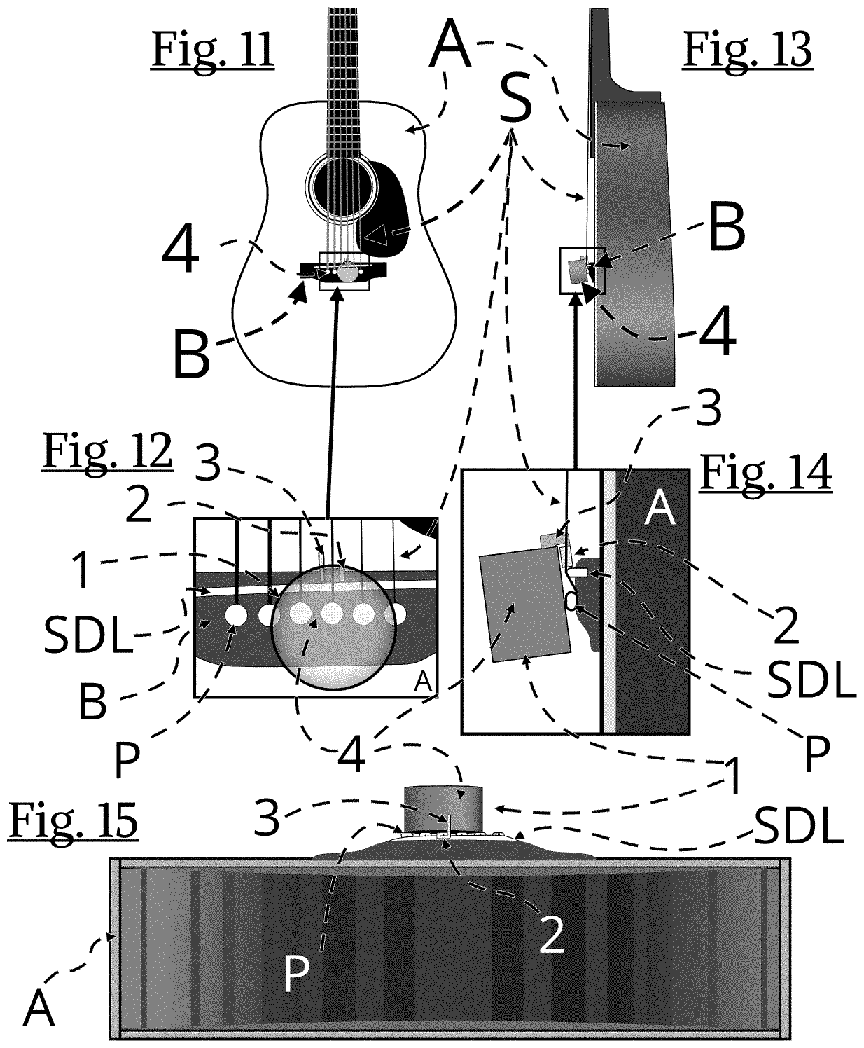

Several depictions and descriptions of alternative embodiments have been included, one having a pair of armatures each coupled with a single anti-faced fastener as depicted in FIGS. 6-10 and FIGS. 16 and 17, and another with a single armature having a single fastener formed into the shape of a right angle as depicted in FIGS. 11-15 and FIGS. 18 and 19. These alternative embodiments offer no functional advantage over the embodiment shown in FIGS. 1-5 and FIGS. 20 and 21 but offer alternative configurations that may be more conducive to differing manufacturing processes whether they be folded material, cast material, or machined material.

The Figures represent particular embodiments, and are not intended to be construed as limiting the invention.

Referring now to the Figures,

FIG. 1 is a front view of an embodiment of the invention 4 attached to the strings S and one or more bridge components, in this case the saddle and pins of a guitar A illustrated having strings S and a bridge B.

FIG. 2 being an expanded view of FIG. 1 shows an embodiment of the invention attached to the strings S and saddle SDL of a guitar A illustrated having strings S, a bridge B, saddle SDL, pins P, and a broad spectrum audio device 1 coupled to a pair of anti-faced fasteners 2, via an armature 3. The fasteners 2 are placed behind the strings S and pressed flush against the saddle SDL of the instrument by the force of gravity acting on the mass of the device. The interaction between the fasteners 2, strings S, and saddle SDL creates a holdfast point of leverage for the device 4. In this specific embodiment of the invention the dimensions of the armature 3 create a cantilever action, using the pins P of the instrument as a fulcrum subsequently applying the weight of the broad spectrum audio device against the pins P, as illustrated in FIG. 4, so that it never contacts the bridge B yet is acoustically coupled to bridge B via the pins P allowing the broad spectrum audio device to not only transmit audio frequencies indirectly through the air but also directly into the the bridge B and subsequent components of the instrument. In addition a secondary acoustic couple is created between the broad spectrum audio device 1 and, in this specific depiction, the saddle SDL of the guitar via the armature 3 and subsequent fasteners 2. Thus the device targets the natural sonic entry points of the instrument: the pins P and the saddle SDL promoting a more accurate simulation of real life play.

FIG. 3 is a side view of an embodiment of the invention 4 attached to the strings S and one or more bridge components, in this case the saddle and pins of a guitar A illustrated having strings S and a bridge B.

FIG. 4 is an exploded view of FIG. 3 that depicts an embodiment of the device 4 attached to the strings S and saddle SDL of a guitar A. FIG. 4 illustrates how the device 4 is hung from the tangent point formed by the strings S and the saddle SDL of the guitar A via a pair of anti-faced fasteners 2, only one of which is visible in this depiction, and the armature 3. The armature 3 is specifically dimensioned to create the proper break angle between the broad spectrum audio device 1 and any suitable bridge component known to the Art, in this case the pins P to allow the cantilever action that the device 4 relies on. In this specific embodiment and application of the device 4, the weight of the broad spectrum audio device 4, hung from the guitar A as previously described, is affixed to the guitar A by the fasteners 2 and positioned against the pins P of the guitar by the armature 3, so that the downward gravitational force acting on the mass of device is redirected laterally into the pins P of the instrument via a cantilever action. This transfer of gravitational force is due to how the device 4 uses the pins P of the guitar as a fulcrum to leverage the weight of the device onto the pins P, saddle SDL, and bridge B of the guitar A. This relationship creates a physical acoustic couple in order to efficiently transfer audio waves into the aforementioned instrument. Depending on the configuration of the acoustic guitar A the device 4 may either use the saddle SDL of the instrument or the pins P of the instrument as a fulcrum. In this particular depiction however, the device 4 is taking advantage of the pins P of the instruments to displace the weight of the device onto the various components of the guitar A. In addition a secondary acoustic couple is created between the broad spectrum audio device 1 and, in this specific depiction, the saddle SDL of the guitar via the armature 3 and subsequent fasteners 2. Thus the device targets the natural sonic entry points of the instrument: the pins P and the saddle SDL promoting a more accurate simulation of real life play. The armature 3 is specifically dimensioned to create the proper break angle between the broad spectrum audio device 1 and any suitable bridge component known to the Art, in this case the pins P, to be conducive to the cantilever action that the device 4 relies on.

FIG. 5 is a cross section view that depicts an embodiment of the device 4 attached to the strings S and saddle SDL of a guitar A. Further, FIG. 5 depicts an end view of a guitar A looking towards the butt of the instrument from the perspective of the headstock so as to illustrate how the fasteners 2 are hooked under the strings S of the instrument A and rests at the tangent formed by the strings S and the saddle SDL. The fasteners 2 are subsequently coupled with the broad spectrum audio device 1 via the armature 3. The armature 3 is specifically dimensioned to create the proper break angle between the broad spectrum audio device 1 and any suitable bridge component known to the Art, in this case the pins P, to be conducive to the cantilever action that the device 4 relies on.

FIG. 6-10 depict an alternative embodiment of the device that is visibly different from other depictions of the device; however, the configuration of fasteners present offers no functional advantage over any of the other depicted configurations of the device.

FIG. 6 is a front view of an embodiment of the invention 4 attached to the strings S and bridge B of a guitar A illustrated having strings S and a bridge B. The depiction calls to attention an alternate configuration of the present invention having a pair of mirrored armatures, each having a single anti-faced fastener so that the armatures, in conjunction with the dimensions of each fastener still disallow the device to become detached from the stringed musical instrument without the direct intent of the user.

FIG. 7 being an expanded view of FIG. 6 shows an embodiment of the invention attached to the strings S and saddle SDL of a guitar A illustrated having strings S, a bridge B, saddle SDL, pins P, and a broad spectrum audio device 1 coupled to a pair of armatures 3, each having a single anti-faced fastener 2 so that the armatures 3, in conjunction with the dimensions of each fastener 2 still disallow the device 4 to become detached from the stringed musical instrument without the direct intent of the user. The fasteners 2 are placed behind the strings S and pressed flush against the saddle SDL of the instrument A by the force of gravity acting on the mass of the device 4. The interaction between the fasteners 2, strings S, and bridge B creates a holdfast point of leverage for the device 4. In this specific embodiment of the invention the dimensions of the armatures 3 create a cantilever action, using the pins P of the instrument A as a fulcrum to apply the weight of the broad spectrum audio device 1 against the pins P, as illustrated in FIG. 9, so that it never contacts the bridge B yet is acoustically coupled to bridge B via the pins P allowing the broad spectrum audio device 1 to not only transmit audio frequencies indirectly through the air but also directly into the the bridge B and subsequent components of the instrument A. In addition a secondary acoustic couple is created between the broad spectrum audio device 1 and, in this specific depiction, the saddle SDL of the guitar A via the armatures 3 and subsequent fasteners 2. Thus the device targets the natural sonic entry points of the instrument A: the pins P and the saddle SDL promoting a more accurate simulation of real life play.

FIG. 8 is a side view of an alternate embodiment of the present invention 4 attached to the strings S and one or more bridge components, in this case the saddle and pins of a guitar A illustrated having strings S and a bridge B.

FIG. 9 is an exploded view of FIG. 8 that depicts an alternate embodiment of the device 4 attached to the strings S and saddle SDL of a guitar A. FIG. 9 illustrates how the device 4 is hung from the tangent point formed by the strings S and the saddle SDL of the guitar A via a pair of anti-faced fasteners 2, only one of which is visible in this depiction, and a pair of armatures 3, only one of which is visible in this depiction. The armatures 3 are specifically dimensioned to create the proper break angle between the broad spectrum audio device 1 and any suitable bridge component known to the Art, in this case the pins P to to allow the cantilever action that the device 4 relies on. In this specific embodiment and application of the device 4, the weight of the broad spectrum audio device 4, hung from the guitar A as previously described, is affixed to the guitar A by the fasteners 2 and position against the pins P of the guitar via the armatures 3, so that the downward gravitational force acting on the mass of the device 4 is redirected laterally into the pins P of the instrument A via a cantilever action. This transfer of gravitational force allows the device 4 to use the pins P of the guitar as a fulcrum to leverage the weight of the device onto the pins P, saddle SDL, and bridge B of the guitar A in order to create a physical acoustic couple. This relationship creates a physical acoustic couple in order to efficiently transfer audio waves into the aforementioned instrument. Depending on the configuration of the instrument A the device 4 may either use the saddle SDL of the instrument or the pins P of the instrument as a fulcrum. In this particular depiction however, the device 4 is taking advantage of the pins P of the instrument A to displace the weight of the device onto the various components of the guitar A. In addition a secondary acoustic couple is created between the broad spectrum audio device 1 and, in this specific depiction, the saddle SDL of the guitar A via the armature 3 and subsequent fasteners 2. Thus the device targets the natural sonic entry points of the instrument A: the pins P and the saddle SDL promoting a more accurate simulation of real life play.

FIG. 10 is a cross section view that depicts an alternate embodiment of the device 4 attached to the strings S and saddle SDL of a guitar A. Further, FIG. 10 depicts an end view of a guitar A looking towards the butt of the instrument from the perspective of the headstock so as to illustrate how the fasteners 2 are hooked under the strings S of the instrument A and rests at the tangent point formed by the strings S and the saddle SDL. The pair of anti-faced fasteners 2 are subsequently coupled with the broad spectrum audio device 1 via a pair of armatures 3. The armatures 3 are specifically dimensioned to create the proper break angle between the broad spectrum audio device 1 and any suitable bridge component known to the Art, in this case the pins P, to allow the cantilever action that the device 4 relies on to function properly.

FIG. 11-15 depict a second alternative embodiment of the device that is visibly different from other depictions of the device; however, the configuration of fasteners present offers no functional advantage over any of the other depicted configurations of the device.

FIG. 11 is a front view of an alternate embodiment of the invention 4 attached to the strings S and bridge B of a guitar A illustrated having strings S and a bridge B. The depiction calls to attention an alternate configuration of the present invention having a singular armature 3 that couples the broad spectrum audio device 1 to a single fastener 2. The fastener 2 is formed into the shape of a right angle or any other suitable form, so that when hooked around a string or strings of a musical instrument A, the device cannot become detached from the stringed musical instrument without the direct intent of the user. The latitude of movement of the device is limited due to the fact that the string S cannot escape the boundary formed between the armature 3 and the wall of the fastener 2.

FIG. 12 being an expanded view of FIG. 11 shows an embodiment of the invention attached to the strings S and saddle SDL of a guitar A illustrated having strings S, a bridge B, saddle SDL, pins P, and a broad spectrum audio device 1 coupled to single fastener 2 formed into the shape of a right angle, via an armature 3. The fastener 2 is placed behind the strings S and pressed flush against the saddle SDL of the instrument by the force of gravity acting on the weight of the device. The interaction between the fastener 2, strings S, and bridge B creates a holdfast point of leverage for the device. In this specific embodiment of the invention the dimensions of the armature 3 create a cantilever action, using the pins P of the instrument as a fulcrum subsequently applying the weight of the broad spectrum audio device against the pins P, as illustrated in FIG. 14, so that it never contacts the bridge B yet is acoustically coupled to bridge B via the pins P allowing the broad spectrum audio device 1 to not only transmit audio frequencies indirectly through the air but also directly into the the bridge B and subsequent components of the instrument A via the pins P. In addition a secondary acoustic couple is created between the broad spectrum audio device 1 and, in this specific depiction, the saddle SDL of the guitar A via the armature 3 and subsequent fastener 2. Thus the device targets the natural sonic entry points of the instruments: the pins P and the saddle SDL promoting a more accurate simulation of real life play. This depiction especially highlights how the string is entrapped by the wall of the fastener 2 and the armature 4.

FIG. 13 is a side view of an alternate embodiment of the present invention 4 attached to one or more strings S and one or more bridge components, illustrated having strings S and a bridge B.

FIG. 14 is an exploded view of FIG. 13 that depicts an alternate embodiment of the device 4 attached to a string S and saddle SDL of a guitar A. FIG. 14 illustrates how the device 4 is hung from the tangent point formed by a string S and the saddle SDL of the guitar A via a singular fastener shaped into the form of a right angle 2, and an armature 3. The armature 3 is specifically dimensioned to create the proper break angle between the broad spectrum audio device 1 and any suitable bridge component known to the Art, in this case the pins P, to allow the cantilever action that the device 4 relies on. The string or strings that the device is applied to are entrapped between the armature 3 and the wall of the fastener 2 and pressed into the floor of the fastener 2 by the weight of the device. In this specific embodiment and application of the device 4, the weight of the broad spectrum audio device 4 is hung from the guitar A as previously described, by the fastener 2 and armature 3 and positioned against the pins P of the guitar via the armature 3, so that the downward gravitational force acting on the mass of the device 4 is redirected laterally into the pins P of the instrument A via a cantilever action. This transfer of gravitational force allows the device 4 to use the pins P of the guitar as a fulcrum to leverage the weight of the device onto the pins P, saddle SDL, and bridge B of the guitar A in order to create a physical acoustic couple. This relationship creates a physical acoustic couple in order to efficiently transfer audio waves into the aforementioned instrument. Depending on the configuration of the instrument A the device 4 may use any number of bridge components of the instrument A as a fulcrum. In this particular depiction however, the device 4 is taking advantage of the pins P of the instrument A to displace the weight of the device onto the various components of the guitar A. In addition a secondary acoustic couple is created between the broad spectrum audio device 1 and, in this specific depiction, the saddle SDL of the guitar A via the armature 3 and subsequent fastener 2. Thus the device targets the natural sonic entry points of the instrument A: the pins P and the saddle SDL promoting a more accurate simulation of real life play.

FIG. 15 is a cross section view that depicts an alternate embodiment of the device 4 attached to the strings S and saddle SDL of a guitar A. Further, FIG. 15 depicts an end view of a guitar A looking towards the butt of the instrument from the perspective of the headstock so as to illustrate how the fastener 2 is hooked under the strings S of the instrument A and rests at the tangent formed by the strings S and the saddle SDL. The fastener 2 formed into a right angle or other suitable form is subsequently coupled with the broad spectrum audio device 1 via a singular armature 3. The armature 3 is specifically dimensioned to create the proper break angle between the broad spectrum audio device 1 and any suitable bridge component known to the Art, in this case the pins P, to allow the cantilever action that the device 4 relies on. This view highlights how the strings, or in this case a singular string S is entrapped by the fastener 2 and the armature 3.

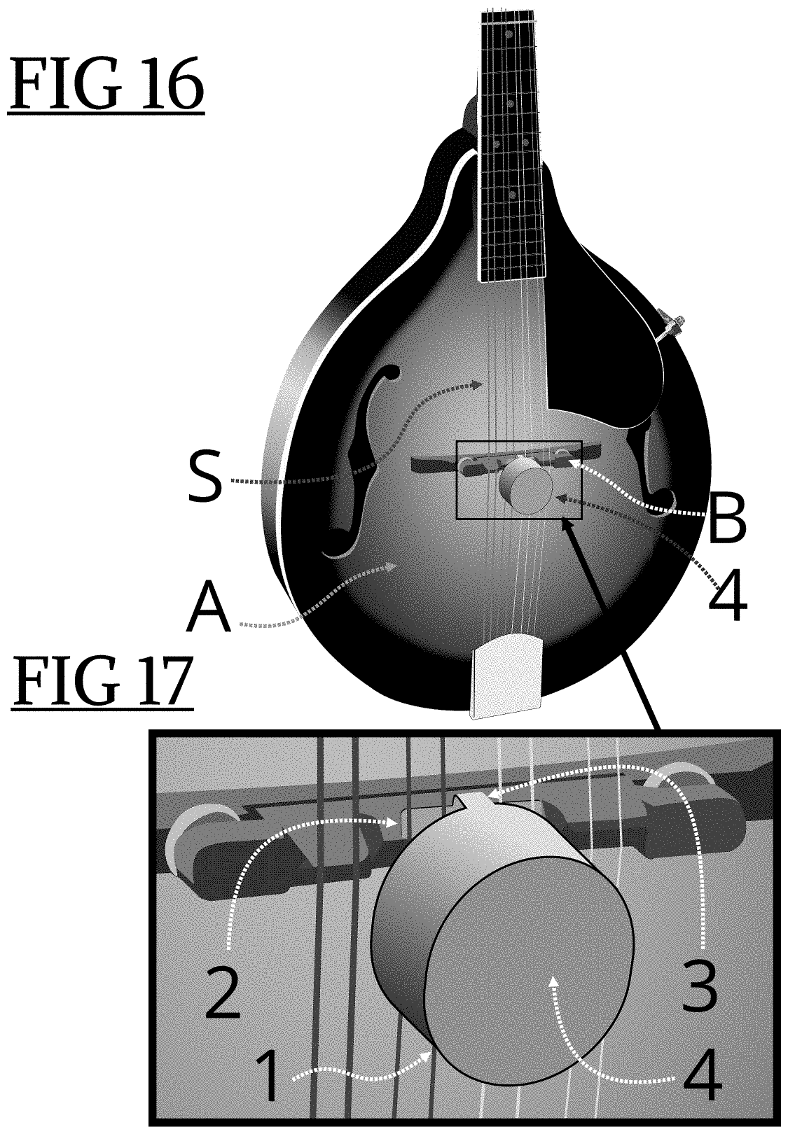

FIG. 16 is a perspective view of an embodiment of the present invention 4 as previously depicted in FIGS. 1-5, shown attached to the bridge B and strings S of a mandolin A.

FIG. 17 is an exploded perspective view of FIG. 20 depicting an embodiment of the present invention as previously depicted in FIGS. 1-5, shown here on a mandolin A, though the embodiment presented is applicable to any stringed musical instrument. The embodiment shows a depiction of the device having a singular armature 3 that couples the broad spectrum audio device 1 to a pair of anti-faced fasteners 2. The fasteners 2 are dimensioned, as previously mentioned, so that the device 4 cannot become unintentionally detached from the musical instrument A. This depiction illuminates in three dimensions how the device can be universally applied to any stringed musical instrument. The device 4 is coupled to the fasteners 2 by the armature 3 and is hung, in this specific case, by the fasteners 2 at the tangent point formed by a strings S and the bridge B of the musical instrument A in order to create a holdfast point of leverage as previously described.

FIG. 18 is a perspective view of an embodiment of the present invention 4 as previously depicted in FIGS. 6-10, shown attached to the bridge B and strings S of a violin A.

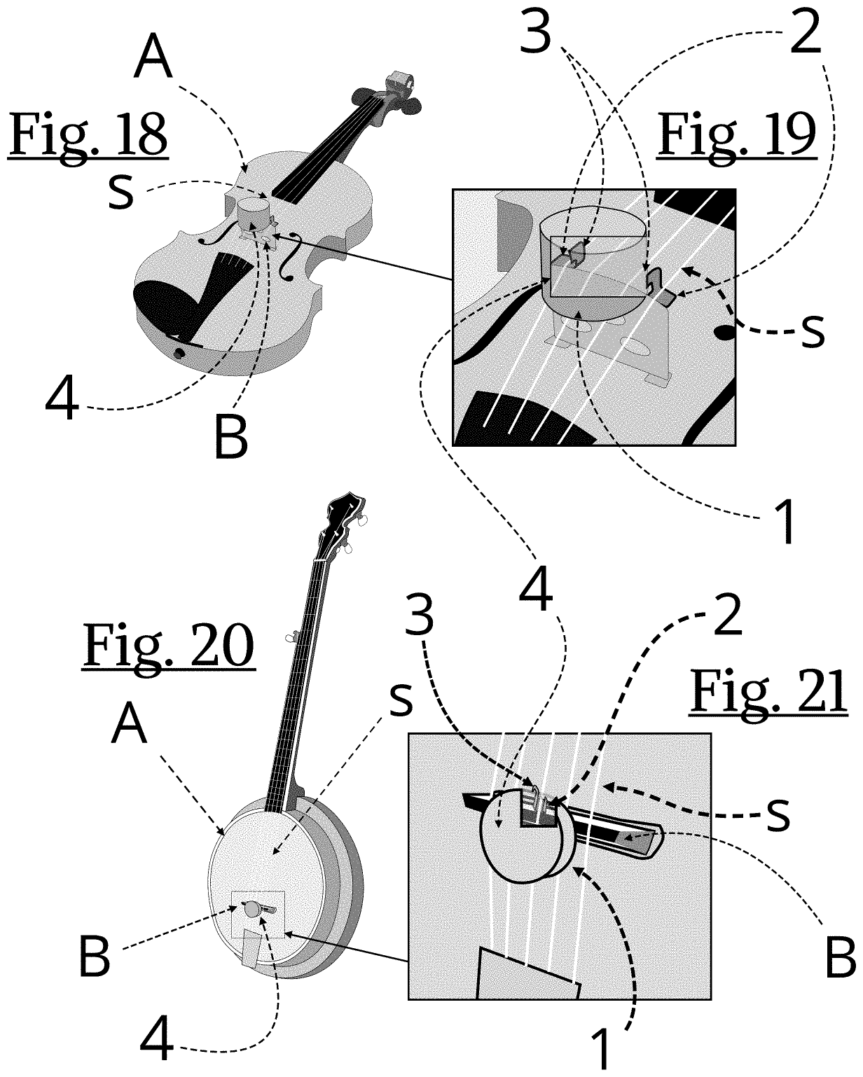

FIG. 19 is an exploded perspective view of FIG. 16 depicting an embodiment of the present invention as previously depicted in FIGS. 6-10, shown here on a violin, though the embodiment in question is applicable to any number of stringed musical instruments. The embodiment shows a depiction of the device 4 having a pair of mirrored armatures 3 each with its own respective anti-faced fastener 2 and illuminates in three dimensions how the device can be universally applied to many stringed musical instruments. The device 4 is coupled to the fasteners 2 by the armatures 3 and is hung, in this specific case, by the fasteners 2 at the tangent point formed by the strings S and the bridge B of the musical instrument A in order to create a holdfast point of leverage as previously described.

FIG. 20 is a perspective view of an embodiment of the present invention as previously depicted in FIGS. 11-15, shown here on a banjo.

FIG. 21 is an exploded perspective view of FIG. 18 depicting an embodiment of the present invention as previously depicted in FIGS. 11-15, shown here on a banjo, though the embodiment presented is applicable to any stringed musical instrument. The embodiment shows a depiction of the device having a singular armature 3 that couples the broad spectrum audio device 1 to a fastener 2. The fastener is formed in the shape of a right angle or any other suitable form that disallows the device to become unintentionally detached from the musical instrument A. This depiction illuminates in three dimensions how the device can be universally applied to any stringed musical instrument. The device 4 is coupled to the fastener 2 by the armature 3 and is hung, in this specific case, by the fastener 2 at the tangent point formed by a string S and the bridge B of the musical instrument A in order to create a holdfast point of leverage as previously described, though in the case of many instruments such as the mandolin the fastener and armature may entrap two or more strings of the stringed musical instrument.

These and other embodiments, advantages, and features of this invention will be apparent from the following description, drawings, and appended claims.

The invention claimed is:

1. A broad spectrum audio device designed to emulate the effects of long term use, in order to accelerate the maturation of stringed musical instruments, composed of, but not limited to: an attachment rail, hook, or any other suitable configuration of one or more fasteners coupled to a broad spectrum audio generator via an armature or armatures, that affixes the device behind the strings of the aforementioned musical instrument, allowing the device to utilize the bridge, bridge pins, and or saddle of the stringed musical instrument as a fulcrum, creating a cantilever action, and a means of autonomously transmitting audio waves from the aforementioned broad spectrum audio generator into the bridge, bridge pins, and or saddle of the stringed musical instrument, accelerating the maturation of the stringed musical instrument; wherein an attachment rail, hook, or any other suitable configuration of one or more fasteners and armature or armatures are dimensioned to allow the attachment rail, hook, or any other suitable configuration of one or more fasteners to rest at the junction of one or more strings and the bridge and or saddle of the stringed musical instrument, positioning the audio generator against the bridge, bridge pins, and or saddle of the stringed musical instrument.

2. The attachment rail, hook, or any other suitable configuration of one or more fasteners of claim 1, wherein the specific dimensions of the attachment rail, hook, or any other suitable configuration of one or more fasteners, in combination with the width of the armature and or distance between armatures prevents the unintentional separation of the device from the stringed musical instrument.

3. The attachment rail, hook, or any other suitable configuration of one or more fasteners of claim 2, being composed of metal, glass, plastic, wood, or any other suitable material and, when installed correctly, lie in direct contact with the bridge and or saddle of the stringed musical instrument so as not to greatly dampen the strings further aiding in the realism of the accelerated maturation process and simulated use.

4. The attachment rail, hook, or any other suitable configuration of one or more fasteners of claim 2, wherein the attachment rail, hook, or any other suitable configuration of one or more fasteners is dimensioned to disallow unintentional separation of the device from the stringed musical instrument due to the dimension of the attachment rail, hook, or any other suitable fastener and or the distance between two or more suitable fasteners being double or more than the distance between any two strings of the stringed musical instrument and or the fastener or fasteners being formed so that the fastener or fasteners in question encompasses a string or strings of the stringed musical instrument so that the device cannot, without the aid of the user, become detached from the aforementioned musical instrument.

5. The attachment rail, hook, or any other suitable configuration of one or more fasteners of claim 2, wherein the attachment rail, hook, or any other suitable configuration of one or more fasteners is formed to encompass one or more strings in a manner that limits the devices longitude of movement so that the device cannot, without the aid of the user, become detached from the aforementioned musical instrument.

6. The attachment rail, hook, or any other suitable configuration of one or more fasteners of claim 2, at no point, assuming proper installation, does the attachment rail, hook, or any other suitable configuration of one or more fasteners rely on friction, adhesion, spring tension, suction, or a “gripping” action to affix the device to any component of the stringed musical instrument; the device is instead detachably attached to the stringed musical instrument due to the aforementioned configuration of one or more suitable fasteners being entrapped by the tangent point formed between the bridge or saddle and the strings of the stringed musical instrument.

7. The armature or armatures of claim 2, wherein the location of the armature or armatures to the attachment rail, hook, or any other suitable configuration of one or more fasteners in combination with the width of the armature and or distance between armatures being wide enough to sufficiently limit the device's latitude of movement yet thin enough to allow any one armature to fit freely between two consecutive strings of the stringed musical instrument without hindering the vibration of said strings when correctly installed so as not to touch any of the aforementioned strings.

8. The armature or armatures of claim 2, wherein the armature is specifically dimensioned to create the proper break angle between the broad spectrum audio device and any suitable bridge component known to the Art, to allow the cantilever action that the device relies on.

9. The device of claim 1, wherein the device leverages the attachment rail, hook, or any other suitable configuration of one or more fasteners against one or more strings using the bridge, bridge pins, and or saddle of the stringed musical instrument as a fulcrum to create a cantilever action ensuring stability of the device and direct acoustic coupling of the device to the stringed musical instrument.

10. The fulcrum of claim 9, comprising the bridge, bridge pins, and or saddle of the stringed musical instrument; wherein the bridge, bridge pins, and or saddle of the stringed musical instrument acts as a fulcrum for the device to cantilever off of.

11. The cantilever action of claim 8, it is known in the Art that as a sound source grows nearer to a physical body, the transfer of sonic energy between the sound source and the acoustic body increases and, on contacting the physical body, the efficiency of sonic transfer greatly increases; as the force creating an acoustic bond between a sound source and a physical body increases, so too does the efficiency of the sonic transfer; the present invention takes advantage of these physical properties as the weight of the device is firmly coupled to the natural sound transfer points of the stringed musical instrument, whether the device be coupled to the pins, bridge, and or saddle of the stringed musical instrument via a cantilever action.

12. The device of claim 1, whereon installing the device on to the stringed musical instrument, the attachment rail, hook, or any other suitable configuration of one or more fasteners is positioned so that each present fastener can be placed between two consecutive strings of the stringed musical instrument wherein, upon rotating the device so that the configuration of one or more fasteners become entrapped by one or more strings of the stringed musical instrument, the device is then navigated vertically down the strings so that the leading edge of the attachment rail, hook, or any other suitable configuration of one or more fasteners rests against the bridge and or saddle of the stringed musical instrument and the broad spectrum audio device is held against the top of the saddle, bridge, and or bridge pins of the stringed musical instrument by gravity.

13. The device of claim 1, whereon uninstalling the device from the stringed musical instrument, the user lifts the device vertically from the bridge allowing the attachment rail, hook, or any other suitable configuration of one or more fasteners, adequate clearance to be rotated so that the attachment rail, hook, or any other suitable configuration of one or more fasteners will no longer be constrained by the aforementioned strings and, converse to the installation process, the device may be removed from the string or strings it was installed on or between.

14. The device of claim 1, comprising a broad spectrum audio device programmed to generate and or transmit audible sonic frequencies directly into the bridge, bridge pins, and or saddle of a stringed musical instrument.

15. The device of claim 1, in particular embodiments may be formed so that the broad spectrum audio device is coupled permanently to a configuration of one or more fasteners via one or more armatures creating a singular integral unit, allowing ease of manufacture of the device.

16. The device of claim 1, in particular embodiments may be formed so that the broad spectrum audio device is removable and replaceable within a substructure that is coupled to one or more fasteners via one or more armatures, allowing customers and manufacturers to stay up to date with rapidly advancing technology while still being able to produce the substructure in bulk.

17. The broad spectrum audio device of claim 12, wherein the user is able to select the frequency and amplitude of any number or shape of waveforms to be transmitted into the stringed musical instrument within the range of 30 Hz to 22 kHz; by allowing the user to curate and modify the array of waveforms being transmitted from the present invention into the stringed musical instrument, the device is made universal to any stringed musical instrument by allowing the creation of a fully customizable outcome of the maturation procedure.

18. The broad spectrum audio device of claim 12, simulates the physical auditory conditioning of extensive play via transmitting a sonic approximation of the complex polyphonic timbre of the instrument in question directly into the stringed musical instrument.

19. The broad spectrum audio device of claim 12, comprising but not limited to a processor, DAC, amplifier, auxiliary input, wireless data receiver, external power and data port, internal battery, battery management circuit, a broad spectrum audio speaker, and an internal microphonic element.

20. The DAC of claim 18, wherein the DAC converts external digital audio data from a processor whether internal or external into analogue values so that the amplifier circuit may use them to drive the broad spectrum audio speaker.

21. The auxiliary input of claim 19, wherein the auxiliary input allows the amplifier circuit to amplify external analogue audio data in order to drive the broad spectrum audio speaker.

22. The wireless data receiver of claim 19, wherein the wireless data receiver allows for the wireless transfer of digital audio data so that it may be converted by the DAC.

23. The external power and data port of claim 19, wherein the external power and data port allows for the simultaneous charging of the internal battery and transfer of external digital audio data via a wired connection.

24. The internal battery of claim 19, wherein the device can function without the need for a wall outlet or other such power supply.

25. The battery management circuit of claim 19, wherein the device may be safely charged and used without the risk of fire or damage to the device due to over or under charging of the internal battery.

26. The broad spectrum audio speaker of claim 19, wherein the broad spectrum audio speaker is coupled with a configuration of one or more fasteners and one or more armatures to allow the device to be secured at the tangent point of the strings and any suitable bridge component known to the Art and cantilevered against the bridge, bridge pins, and or saddle of the stringed musical instrument so as to allow the strings to freely vibrate sympathetically with the sonic content emanating from the broad spectrum audio speaker, in doing so enhancing the realism of simulated play and the accelerated maturation process of the stringed musical instrument.

27. The internal microphonic element of claim 19, wherein the broad spectrum audio device is capable of receiving real time audio feedback from a stringed musical instrument via an internal microphonic element and decoding said audio feedback, whether internally or via an external microcontroller or processor, so that the user may analyze the metrics of the maturation process and adjust the settings of the device accordingly.

28. The broad spectrum audio speaker of claim 19, wherein the broad spectrum audio speaker is in direct contact with the bridge, bridge pins, and or saddle of the stringed musical instrument so as to enhance the realism of simulated play due to the fact that the bridge, pins and or saddle are the natural transfer points for sonic frequencies when the stringed musical instrument is being played; these results cannot be obtained by positioning the device on the strings, neck, body, or any other part of the stringed musical instrument.
